(19) United States
(12) Patent Application Publication
(10) Pub. No.: US 2009/0107990 A1
(43) Pub. Date: Apr. 30, 2009

(54) Electromagnetically Shielded Induction Heating Apparatus

(76) Inventor: Jean LOVENS, Embourg (BE)

Correspondence Address: PHILIP O. POST;INDEL, INC., PO BOX 157, RANCOCAS, NJ, 08073, US

(21) Appl. No.: 12/347,653

(22) Filed: Dec. 31, 2008

Related U.S. Application Data
(62) Division of application No. 11/650,752, filed on Jan. 8, 2007.
(60) Provisional application No. 60/757,355, filed on Jan. 9, 2006.

(51) Int. Cl. H05B 6/26

(52) U.S. Cl. 219/651

(57) ABSTRACT

An induction heating apparatus comprises a substantially gas-tight enclosure through which a workpiece passes. An induction means surrounds the exterior of the enclosure and an ac current flow though the induction means establishes a magnetic field that couples with the workpiece to inductively heat the workpiece. The gas-tight enclosure may comprise a non-electrically conductive material to permit passage of the magnetic field for coupling with the workpiece and an electromagnetic shield material for restricting the regions of the magnetic field. In alternate examples an electromagnetic shunt located around the induction means is used in place of, or in combination with, the electromagnetic shield material to restrict the magnetic field in a direction towards the workpiece. In other examples of the invention one or more flexible elements may be used with the non-electrically conductive material, for example, to compensate for thermal expansion of one or more process chambers adjacent to the gas-tight enclosure.

### CROSS REFERENCE TO RELATED APPLICATIONS

This is a divisional application of application Ser. No. 11/650,752, filed Jan. 8, 2007, which application claims the benefit of U.S. Provisional Application No. 60/757,355, filed Jan. 9, 2006, both of which applications are hereby incorporated herein by reference in their entireties.

### FIELD OF THE INVENTION

The present invention generally relates to an electric induction heating apparatus wherein a gas-tight enclosure isolates a workpiece from the surrounding environment while an induction heating means located outside of the enclosure inductively heats the workpiece within the enclosure.

### BACKGROUND OF THE INVENTION

A prior art induction heating apparatus comprises an induction means and a non-metallic gas-tight enclosure disposed around a continuous moving product, such as a metal strip or wire. The gas-tight enclosure is thermally and electrically insulated and surrounds the moving product with a non-conductive enclosure. The induction means is located around the outside of the enclosure and is connected to a suitable ac power source so that a magnetic field is established around the induction means when ac current flows through the induction means. The field couples with the moving product and inductively heats the product. The non-conductive gas-tight enclosure must extend a sufficient distance (at least 200 mm) upstream and downstream of the induction means, parallel to the direction of the moving product, to create a region that encloses the magnetic field upstream and downstream of the enclosure. At least in installations where fitting of the gas-tight enclosure in the induction heating line is tight, this requirement creates an extended distance that is a problem, particularly when the enclosure is attached to an upstream or downstream processing chamber that is constructed of an electrically conductive material. Moreover high power induction means generate high intensity electromagnetic fields that typically require much longer distances upstream and downstream to avoid induced heating of connected chambers or fittings used to connect the chambers together. Further when the gas-tight enclosure is used as an intermediate chamber between upstream and downstream processing chambers, in some applications thermal heating of the upstream or downstream chamber can exert compression forces on the intermediate chamber.

Therefore there is the need for an induction heating apparatus wherein the length of the gas-tight enclosure that is parallel to the direction of the moving product is substantially limited to the length of the induction means and/or the gas-tight enclosure can compensate for compression forces exerted by thermal expansion of adjacent chambers.

### BRIEF SUMMARY OF THE INVENTION

In one aspect the present invention is an induction heating apparatus and method for inductively heating a strip or other workpiece moving through a substantially gas-tight enclosure. Induction means are located around the outside of the enclosure to carry an ac current for generating a magnetic field that penetrates the enclosure and inductively heats the workpiece passing through the enclosure. The enclosure comprises a non-electrically conductive material to permit coupling of the magnetic field with the workpiece passing through the enclosure and an electromagnetic shield material for restricting the regions of the magnetic field. The induction heating apparatus is of particular advantage when used as an intermediate heating chamber that is joined on either side to a process chamber that is constructed, at least in part, of an electrically conductive material.

In another aspect of the present invention, the gas-tight enclosure may comprise a non-electrically conductive material and an electromagnetic shunt may be placed around the induction means outside of the enclosure to restrict the magnetic field upstream and downstream of the induction means.

In another aspect of the present invention, the gas-tight enclosure may comprise a non-electrically conductive material that includes one or more flexible elements to compensate for thermal expansion of one or more connected chambers.

The above and other aspects of the invention are set forth in this specification and the appended claims.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a cross sectional view of the induction heating apparatus of the present invention shown in FIG. 2 through line A-A in FIG. 2.

FIG. 2 is a perspective view of one example of an induction heating apparatus of the present invention.

FIG. 3 is a cross sectional view of another example of an induction heating apparatus of the present invention.

FIG. 4 is a cross sectional view of another example of an induction heating apparatus of the present invention.

FIG. 5 is a cross sectional view of another example of an induction heating apparatus of the present invention.

FIG. 6 is a cross sectional view of another example of an induction heating apparatus of the present invention.

FIG. 7 is a cross sectional view of the example of the induction heating apparatus of the present invention shown in FIG. 1 and FIG. 2 and adjacent processing chambers.

FIG. 8 is a cross-sectional view of another example of the induction heating apparatus of the present invention and one or more adjacent processing chambers.

FIG. 9 is a cross-sectional view of another example of the induction heating apparatus of the present invention and one or more adjacent processing chambers.

FIG. 10 is a cross-sectional view of another example of the induction heating apparatus of the present invention and one or more adjacent processing chambers.

FIG. 11 is a cross-sectional view of another example of the induction heating apparatus of the present invention and one or more adjacent processing chambers.

### DETAILED DESCRIPTION OF THE INVENTION

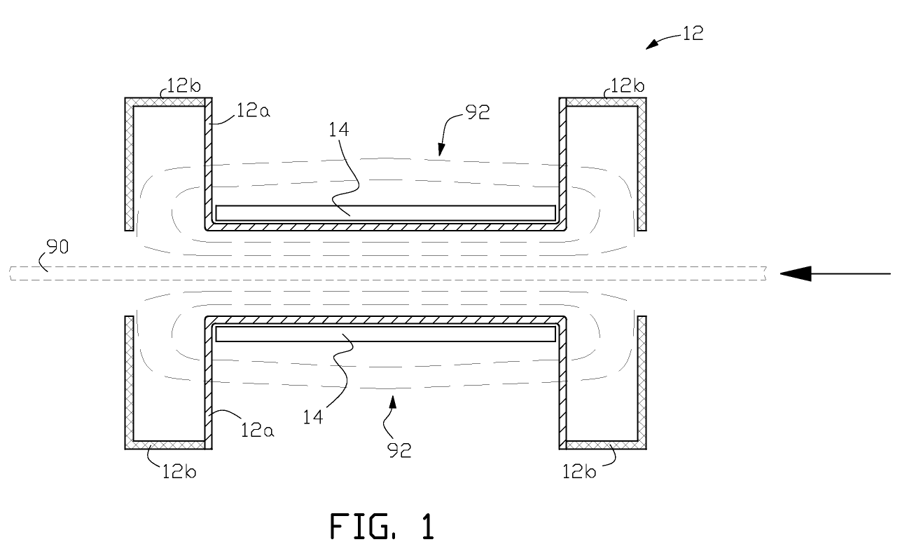

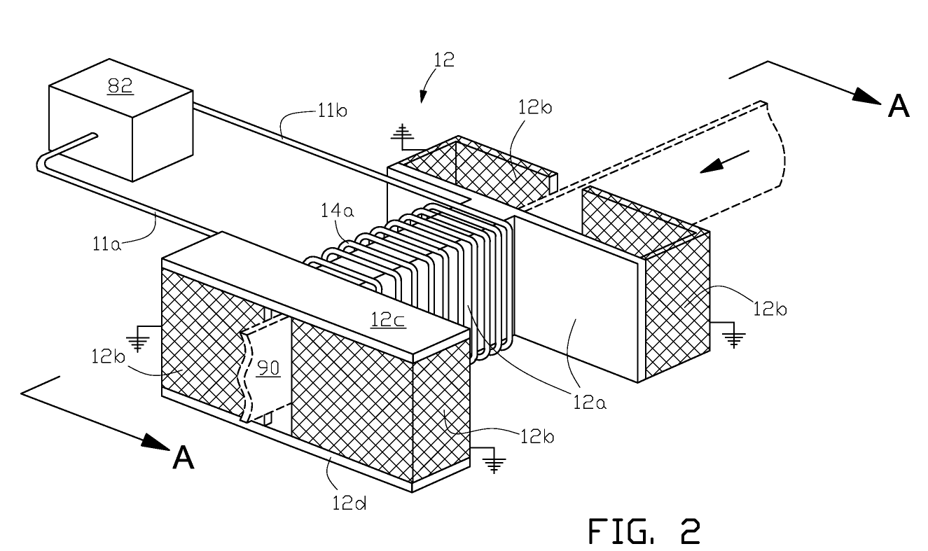

Referring now to the drawings, wherein like numerals indicate like elements, there is shown in FIG. 1 and FIG. 2, one example of the induction heating apparatus of the present invention. Gas-tight enclosure 12 provides a means for substantially enclosing workpiece 90 from the surrounding environment as the workpiece passes through the enclosure in the direction indicated by the arrow (establishing an upstream and downstream orientation through the enclosure). Induction means 14 or 14a is located outside of enclosure 12 and is connected to a suitable ac power supply 82 so that current flowing through the induction means establishes a magnetic field (represented by typical flux lines 92—shown as dashed lines) that magnetically couples with strip 90 as it passes through the enclosure to inductively heat the strip.

Enclosure 12 comprises non-electrically conductive material 12a and electromagnetic shield material 12b. The non-electrically conductive material is used at least in the regions of the enclosure where the magnetic field passes to couple with the workpiece as it passes through the enclosure. In this non-limiting example of the invention, the electromagnetic shield material is used at least in the regions of the enclosure where the magnetic field extends upstream and downstream of the induction means, thereby restricting the upstream and downstream travel of the magnetic field and substantially decreasing the overall length of the induction heating apparatus.

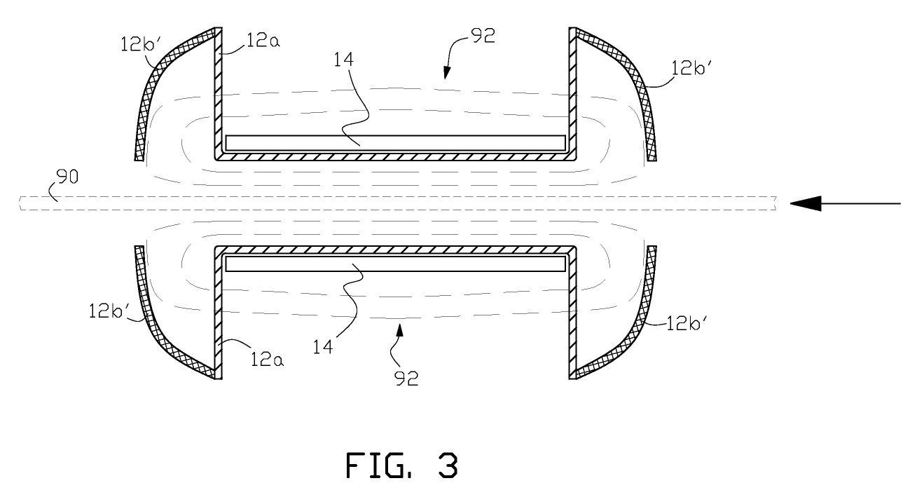

The “L-shaped” electromagnetic shield material of enclosure 12 as shown in FIG. 1 and FIG. 2 is one non-limiting arrangement that can be used in the induction heating apparatus of the present invention. For purposes of the present invention, the upstream and downstream electromagnetic shield regions of enclosure 12 only need to be of sufficient size and shape to restrict the magnetic field from extending upstream or downstream of the enclosure. For example in alternative examples of the invention electromagnetic shield material 12b′ can be arcuate as shown in FIG. 3.

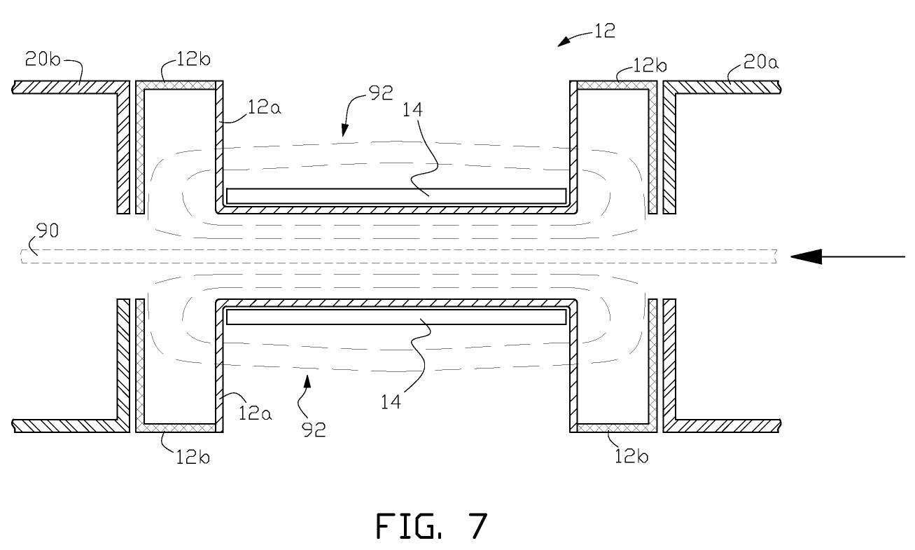

Use of the electromagnetic shield regions is of particular advantage when the induction heating apparatus of the present invention is used as an intermediate heating chamber that is connected to an upstream and/or downstream process chamber. For example, in FIG. 7, gas-tight enclosure 12 of the present invention is used as an intermediate induction heating chamber between upstream and/or downstream process chamber 20a and/or chamber 20b (shown in partial cross sections), respectively, which have regions adjacent to enclosure 12 that may be composed, at least in part, of an electrically conductive material.

The electromagnetic shield material can comprise an electrically conductive material, such as a copper or an aluminum composition plate, or a high or medium magnetic permeability material, such as but not limited to, MuMetal formed in a sheet, foil or mesh, and electrically grounded, as suitable for a particular application.

The enclosure is substantially gas-tight in that openings must be provided for pass through of the workpiece, and can be thermally insulated to retain heat in the enclosure. The enclosure may optionally include means for injecting a gaseous composition into the enclosure and/or means for evacuating a gaseous composition from the chamber. The enclosure may include additional structural elements that the magnetic field coupling with the workpiece does not pass through.

The utilized heating inductor, or induction means 14, may be any type of heating inductor, including but not limited to, one or more inductors shaped as coils or sheets, connected in series and/or parallel, wherein the one or more inductors generate longitudinal or transverse flux fields. FIG. 2 illustrates one example of the present invention wherein solenoidal coil 14a is the induction means. Coil 14a surrounds enclosure 12 and uses coil terminations 11a and 11b for suitable connection to ac power supply 82. Current from the supply generates the magnetic field around the coil that couples with the workpiece to inductively heat the workpiece. In other examples of the invention the induction means may comprise a coil pair with the coil pair positioned on opposing sides of the enclosure to produce a transverse flux field, or any other suitable coil arrangement.

In FIG. 2 top and bottom enclosure sealing elements 12c and 12d (not shown installed on the upstream end of the enclosure) over and under the magnetic shield material may be composed of any suitable material. Depending upon the arrangement, an electrically conductive material may be preferred.

In FIG. 2 non-electrically conductive material 12a extends perpendicularly to the surface of strip 90; other examples of the invention, the non-electrically conductive material may also end perpendicular to the edges of the strip.

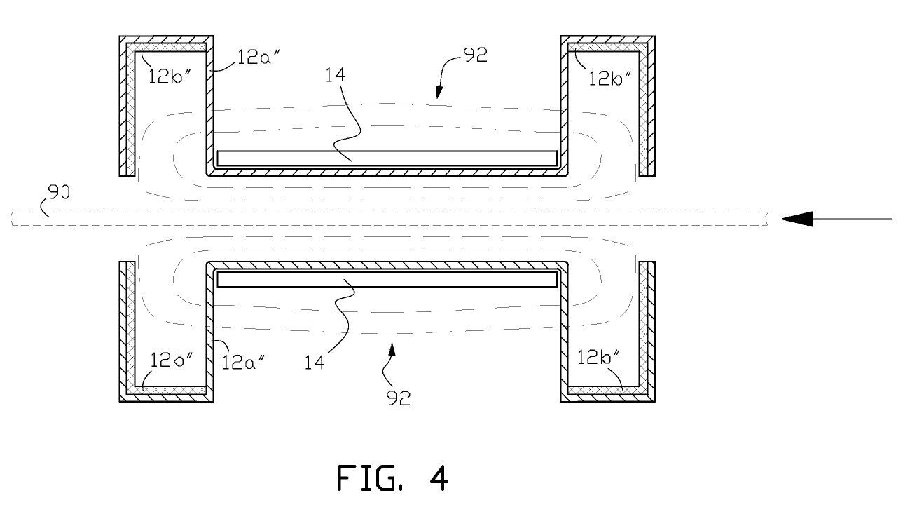

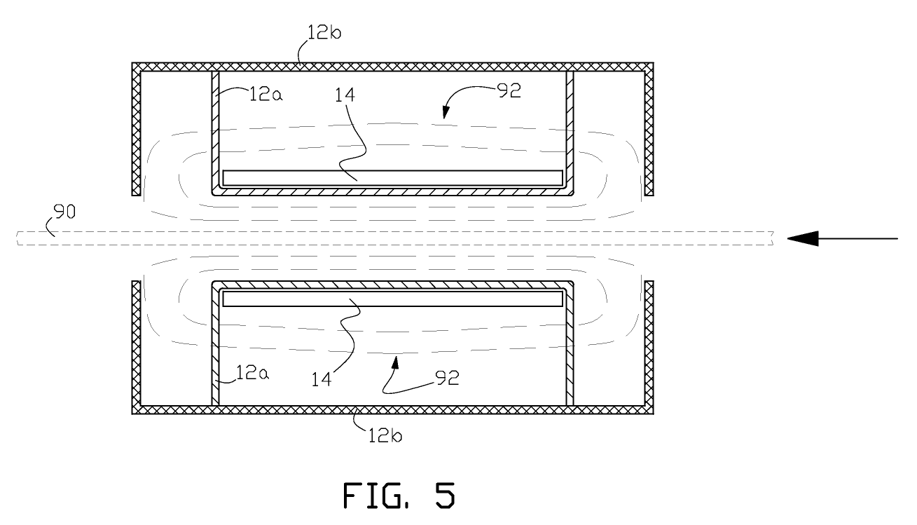

In alternate examples of the invention, the gas-tight enclosure may comprise a non-electrically conductive material 12a″ in which electromagnetic shield material 12b″ is disposed as shown in FIG. 4. In other examples of the invention electromagnetic shield material 12b may extend along the length of the induction means to restrict the magnetic field in the direction perpendicular to the plane of the workpiece as shown in FIG. 5.

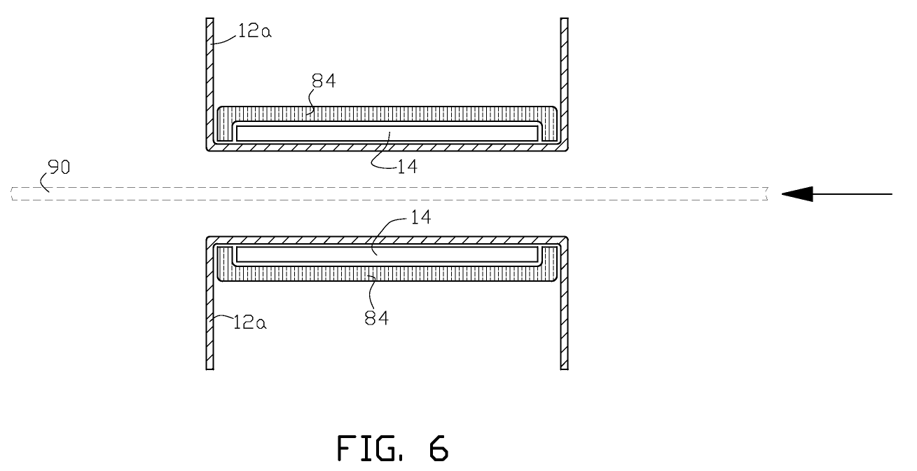

FIG. 6 illustrates another example of the induction heating apparatus of present invention wherein the enclosure comprises non-electrically conductive materially 12a and electromagnetic shunt 84, which is sufficiently disposed around induction means 14 to restrict the upstream and downstream penetration of the magnetic field when an ac current flows through the induction means. In other examples of the invention one or more electromagnetic shunts may be combined with electromagnetic shield material as disclosed above.

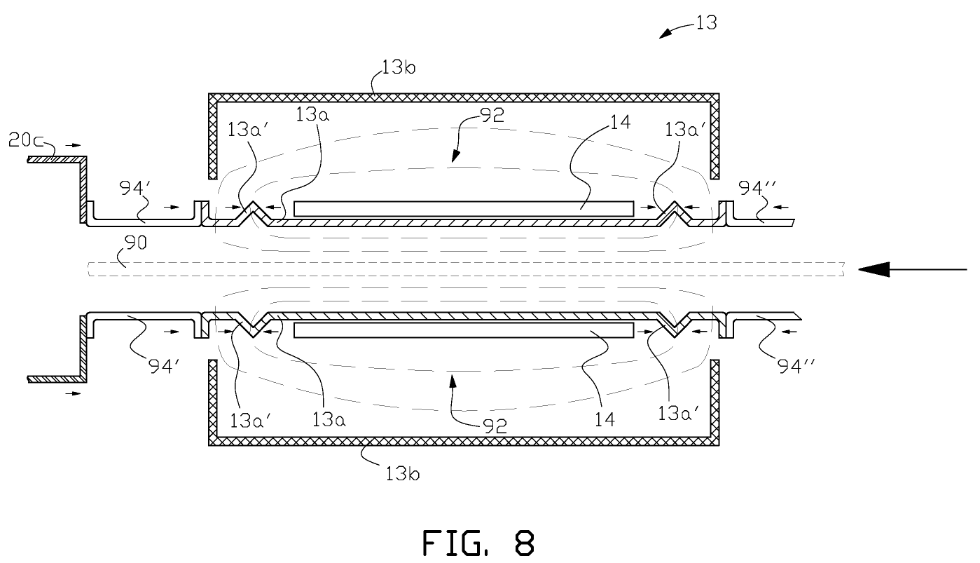

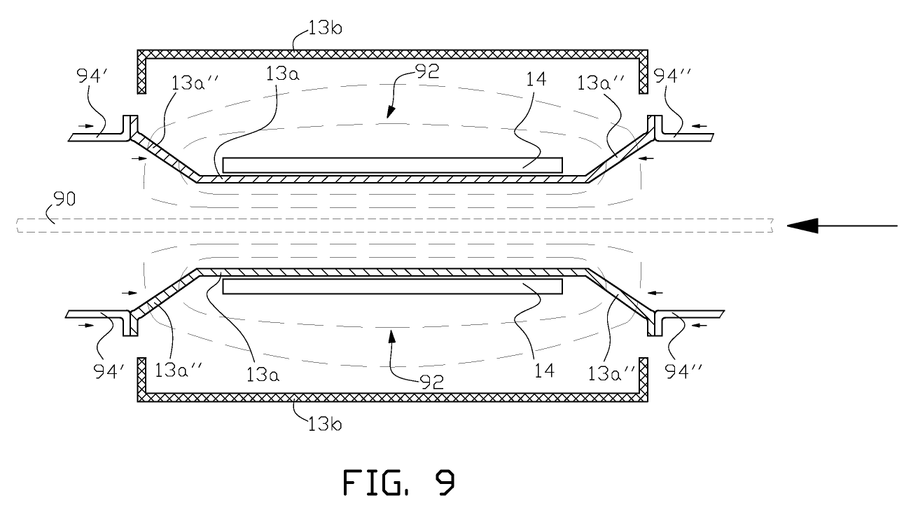

FIG. 8 through FIG. 11 illustrate non-limiting examples of the induction heating apparatus of the present invention wherein the non-electrically conductive material 13a of gas-tight enclosure 13 includes one or more flexible features that permit the gas-tight enclosure to withstand thermal expansion in the upstream and downstream directions. This is of particular advantage when the gas-tight enclosure is connected to an upstream and/or downstream process chamber, as illustrated by downstream process chamber 20c (shown in partial cross section) in FIG. 8. In this non-limiting arrangement adjacent chamber 20c is connected to enclosure 13 by connecting element 94′, which may be, for example, a stainless steel flange. The opposing upstream end of enclosure 13 may also be connected to an upstream process chamber (not shown in the figures) by connecting element 94″. In FIG. 8 the flexible feature of non-electrically conductive material 13a is V-shaped element 13a′ disposed at the opposing ends of the non-electrically conductive material. As adjacent downstream and/or upstream process chambers may expand during heating, the legs of the V-shaped elements will compress together in the directions indicated by the arrows to compensate for the expansion of the adjacent chambers, particularly in the upstream and downstream directions. Connecting elements 94′ and/or 94″ can be arranged so that they move in the upstream and downstream directions as enclosure 13 reacts to thermal effects on the adjacent chambers. In FIG. 9 the flexible feature of the non-electrically conductive material 13a is sloped element 13a″ disposed at the opposing ends of the non-electrically conductive material. As shown in FIG. 9 element 13a″ slopes away from the surface of workpiece 90 at the upstream and downstream ends of enclosure 13. As enclosure 13 reacts to thermal effects on the adjacent chambers, the angle of sloped element 13a″ relative to a surface of workpiece 90 increases to compensate for the expansion of the adjacent chambers, particularly in the upstream and downstream directions. In FIG. 8 and FIG. 9 electromagnetic shield material may be provided at least in the regions of enclosure where the magnetic field extends upstream and downstream of the induction means; optionally, as illustrated by electromagnetic shield material 13b in FIG. 8 and FIG. 9, the material may also be provided along the length of the induction means to restrict the magnetic field in the direction perpendicular to the plane of the workpiece.

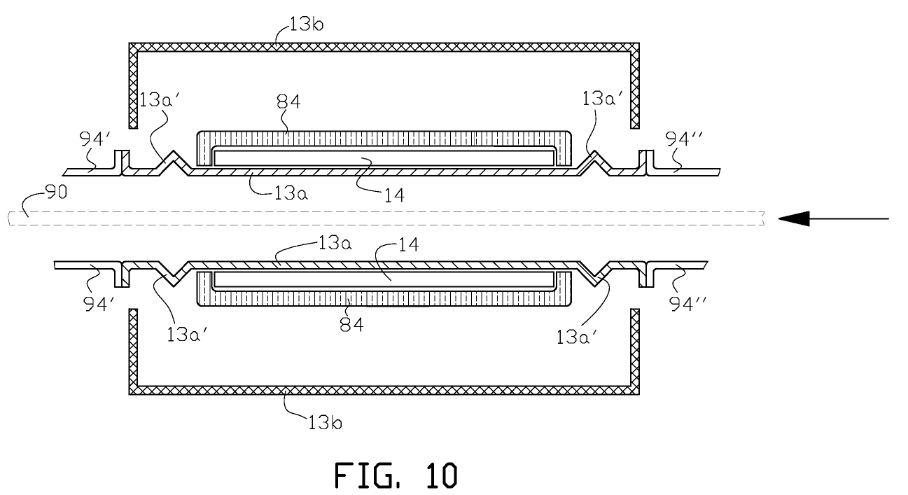

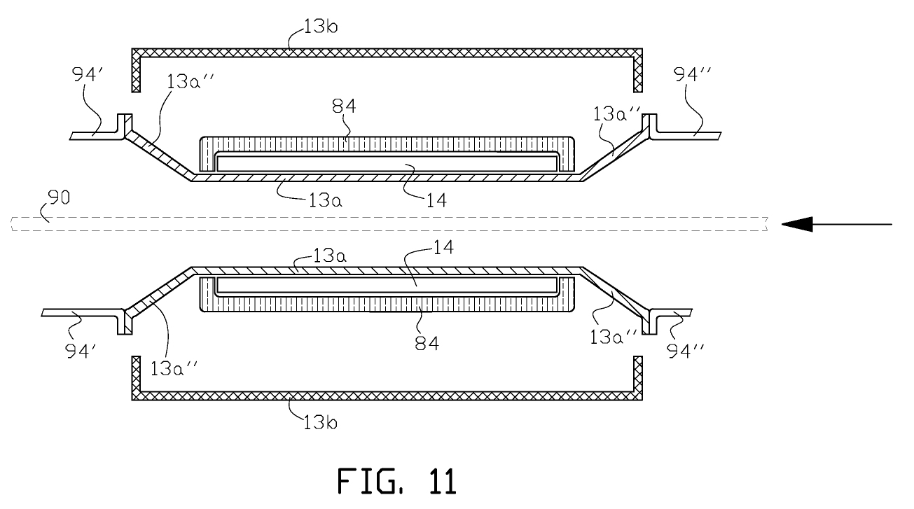

FIG. 10 and FIG. 11 illustrate use of V-shaped element 13a′ and sloped element 13a″, respectively, with a gas-tight enclosure that utilizes one or more electromagnetic shunts 84 similar to the example of the invention illustrated in FIG. 6 and described above. In FIG. 8 through FIG. 11, V-shaped element 13a′ and slopped element 13a″ represent two non-limiting examples of a flexible feature for the non-electrically conductive material of a gas-tight enclosure. Although a defined quantity of flexible features are illustrated in these figures, the number of flexible features in a particular example of the invention will depend upon the application. Further the flexible features of the non-electrically conductive material illustrated in these figures may be incorporated into other examples of the invention.

In all examples of the invention, workpiece 90 may comprise a continuous workpiece, such as a strip or wire, or multiple discrete workpieces suitably fed through the enclosure, for example, by a conveyor system.

The above examples of the invention have been provided merely for the purpose of explanation and are in no way to be construed as limiting of the present invention. While the invention has been described with reference to various embodiments, the words used herein are words of description and illustration, rather than words of limitations. Although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto, and changes may be made without departing from the scope of the invention in its aspects.

1. An induction heating apparatus comprising a substantially gas-tight enclosure through which a workpiece passes, and an induction means disposed around the outside of the enclosure to carry an ac current for generating a magnetic field that penetrates the enclosure and inductively heats the workpiece passing through the enclosure,
the improvement comprising,
the substantially gas-tight enclosure comprising a non-electrically conductive material to permit coupling of the magnetic field with the workpiece passing through the enclosure and at least one electromagnetic shunt disposed around the induction means to restrict the magnetic field in a direction towards the workpiece.

2. The induction heating apparatus of claim 1 wherein the non-electrically conductive material further comprises at least one flexible element for movement of the gas-tight enclosure in the upstream and downstream directions of the enclosure.

3. The induction heating apparatus of claim 2 wherein the at least one flexible element is a generally V-shaped element or a generally sloped upstream or downstream end element of the non-electrically conductive material.

4. An induction heating apparatus comprising a substantially gas-tight enclosure through which a workpiece passes, and an induction means disposed around the outside of the enclosure to carry an ac current for generating a magnetic field that penetrates the enclosure and inductively heats the workpiece passing through the enclosure,
the improvement comprising,
the substantially gas-tight enclosure comprising a non-electrically conductive material to permit coupling of the magnetic field with the workpiece passing through the enclosure, the non-electrically conductive material having at least one flexible element for movement of the gas-tight enclosure in the upstream and downstream directions of the enclosure, and at least one electromagnetic shunt disposed around the induction means to restrict the magnetic field in a direction towards the workpiece.

5. The apparatus of claim 4 wherein the at least one flexible element comprises a generally V-shaped element or a generally sloped upstream or downstream end element of the non-electrically conductive material.
